(19) United States
(12) Patent Application Publication
(10) Pub. No.: US 2015/0343977 A1
(43) Pub. Date: Dec. 3, 2015

(54) AIRBAG SYSTEM

(71) Applicant: HYUNDAI MOBIS Co., Ltd., Yongin-si (KR)

(72) Inventor: Sug Hyun JEONG, Yongin-si (KR)

(21) Appl. No.: 14/609,483

(22) Filed: Jan. 30, 2015

(30) Foreign Application Priority Data
May 28, 2014 (KR) 10-2014-0064155

(51) Int. Cl. B60R 21/0132

(52) U.S. Cl. CPC B60R 21/0132; B60R 2021/01322; B60R 2021/01286

(57) ABSTRACT

Disclosed is an airbag system that efficiently copes with a small overlap collision of a vehicle. The airbag system according to the exemplary embodiment of the present invention includes a front airbag module; a side airbag module; a central sensor measuring the forward acceleration a lateral acceleration; a left side sensor measuring the forward acceleration and the lateral acceleration; a right side sensor measuring the forward acceleration the lateral acceleration; and a controller configured to determine a small overlap collision to expand the front airbag module and the side airbag module.

### CROSS-REFERENCE TO RELATED APPLICATIONS

The present application claims priority to Korean Patent Application Number 10-2014-0064155 filed May 28, 2014, the entire contents of which application is incorporated herein for all purposes by this reference.

### TECHNICAL FIELD

The present invention relates to an airbag system, and more particularly, to an airbag system that efficiently copes with a small overlap collision of a vehicle.

### BACKGROUND

In general, a vehicle includes various safety devices for protecting a driver and a passenger against unexpected situations which may occur at some time, and the representative safety device is an airbag system for directly protecting the driver and the passenger seated in the vehicle.

The airbag system serves to protect the driver or the passenger from objects such as glass, a panel, and the like of the vehicle by covering the driver or the passenger while expanding an airbag at a high speed by momentarily injecting compression gas in the airbag according to a sensed impact when the vehicle collides.

In recent years, stability for the small overlap collision in which only a part of a front side of the vehicle collides head-on is required and the smooth airbag expansion is required in response to the small overlap collision.

### SUMMARY

The present invention has been made in an effort to provide an airbag system that efficiently copes with a small overlap collision of a vehicle.

The objects of the present invention are not limited to the aforementioned objects, and other objects, which are not mentioned above, will be apparent to those skilled in the art from the following description.

An exemplary embodiment of the present invention provides an airbag system including: a front airbag module expanded to a front of the passenger to protect the front of the passenger; a side airbag module expanded to the side of the passenger to protect the side of the passenger; a central sensor disposed at the center of a vehicle, and measuring the forward acceleration to output a forward acceleration of the central sensor and measuring a lateral acceleration to output a lateral acceleration of the central sensor; a left side sensor disposed on a left side of the vehicle, and measuring the forward acceleration to output a forward acceleration of the left side sensor and measuring the lateral acceleration to output a lateral acceleration of the left side sensor; a right side sensor disposed on a right side of the vehicle, and measuring the forward acceleration to output a forward acceleration of the right side sensor and measuring the lateral acceleration to output a lateral acceleration of the right side sensor; and a controller configured to determine a small overlap collision from the forward acceleration of the central sensor and the lateral acceleration of the central sensor, and the forward acceleration of the left side sensor and the forward acceleration of the right side sensor to expand the front airbag module and the side airbag module.

Other detailed contents of the exemplary embodiments are included in the description and drawings.

According to the airbag system of the exemplary embodiments of the present invention, there are one or more effects as follows.

First, a front airbag and a side airbag can be smoothly expanded upon a small overlap collision.

Second, the small overlap collision can be accurately determined by using the side sensor measuring a forward acceleration.

The effects of the present invention are not limited to the aforementioned effects, and other effects, which are not mentioned above, will be apparent to those skilled in the art from the description included in the appended claims.

### BRIEF DESCRIPTION OF THE DRAWINGS

FIG. 1 is a diagram illustrating a layout of an airbag system in a vehicle according to an exemplary embodiment of the present invention.

FIG. 2 is a diagram illustrating an operation of the airbag system illustrated in FIG. 1.

### DETAILED DESCRIPTION

Various advantages and features of the present invention and methods accomplishing them will become apparent from exemplary embodiments described below in detail with reference to the accompanying drawings. However, the present invention is not limited to the exemplary embodiment disclosed herein but will be implemented in various forms. The exemplary embodiments introduced herein are provided to make disclosed contents thorough and complete and sufficiently transfer the spirit of the present invention to those skilled in the art. Therefore, the present invention will be defined only by the appended claims. Like reference numerals indicate like elements throughout the specification.

Hereinafter, the present invention will be described with reference to drawings for describing an airbag system by an exemplary embodiment of the present invention.

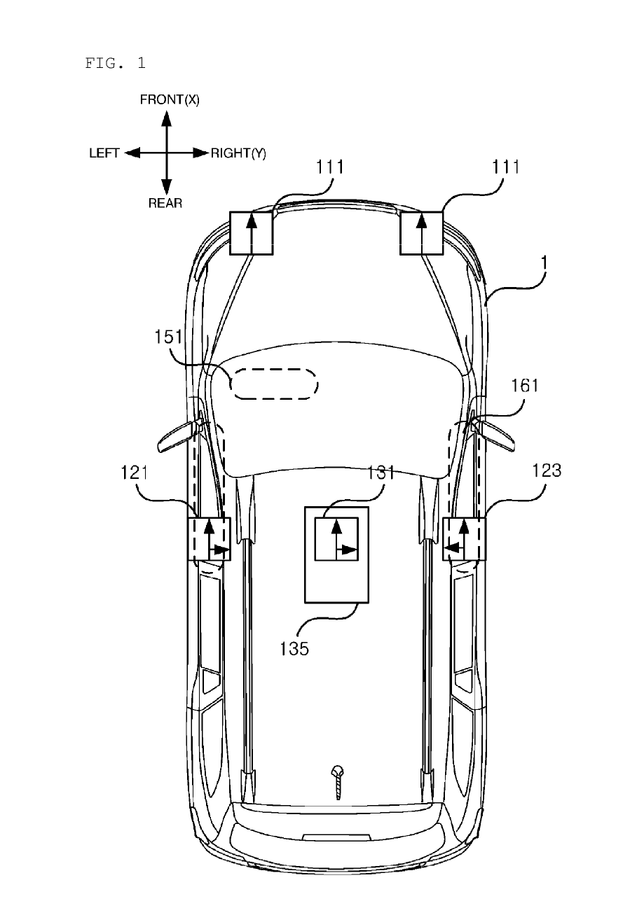

FIG. 1 is a diagram illustrating a layout of an airbag system in a vehicle according to an exemplary embodiment of the present invention.

Hereinafter, a front side or a front of a vehicle 1 means a progress direction or an engine room-direction of a general vehicle 1 and a forward direction or a X-axis direction means a direction having the progress direction of the vehicle 1 as an axis. Further, the side of the vehicle 1 means a side at which a passenger boarding door of the general vehicle 1 is disposed as a direction vertical to the front side or the front of the vehicle. A left side of the vehicle 1 is a left direction around a driver and a right side of the vehicle 1 is a right direction around the driver. A lateral direction or a Y-axis direction as a direction having the direction vertical to the progress direction of the vehicle 1 as the axis is a direction linking both sides. Terms regarding other directions may be derived from the above contents.

The airbag system according to the exemplary embodiment of the present invention includes a front airbag module 151 expanded to a front of the passenger to protect the front of the passenger, a side airbag module 161 expanded to the side of the passenger to protect the side of the passenger, a front sensor 111 disposed on a front of the vehicle 1, and measuring a forward acceleration to output a forward acceleration of the front sensor, a central sensor 131 disposed at the center of the vehicle 1, and measuring the forward acceleration to output a forward acceleration of the central sensor and measuring a lateral acceleration to output a lateral acceleration of the central sensor, a left side sensor 121 disposed on a left side of the vehicle 1, and measuring the forward acceleration to output a forward acceleration of the left side sensor and measuring the lateral acceleration to output a lateral acceleration of the left side sensor, a right side sensor 123 disposed on a left side of the vehicle 1, and measuring the forward acceleration to output a forward acceleration of the right side sensor and measuring the lateral acceleration to output a lateral acceleration of the right side sensor, and a controller 135 configured to determine a small overlap collision from the forward acceleration of the central sensor and the lateral acceleration of the central sensor, and the forward acceleration of the left side sensor and the forward acceleration of the right side sensor to expand the front airbag module 151 and the side airbag module 161.

The front airbag module 151 as an airbag module that is expanded when the vehicle 1 is impacted to protect a head front or a chest front of the passenger (a driver or an occupant) of the vehicle 1 means a driver-seat airbag module and/or a passenger-seat airbag module. The front airbag module 151 is disposed in a handle, an instrument panel, and the like of the vehicle 1. In the front airbag module 151, a mounted front airbag is expanded according to a control by the controller 135.

The side airbag module 161 as an airbag module that is expanded when the vehicle 1 is impacted to protect a head side or a body side of the passenger of the vehicle 1 means a curtain airbag module and/or a side airbag module. The side airbag module 161 is disposed in a roof, a pillar, a seat, and the like of the vehicle. In the side airbag module 161, a mounted side airbag is expanded according to the control by the controller 135.

The front sensor 111 is disposed on the front of the vehicle 1. The front sensor 111 is disposed on a front bumper or a front frame of the vehicle 1. The plurality of front sensors 111 may be provided on the front of the vehicle, as illustrated in FIG. 1.

The front sensor 111 measures the forward acceleration of the vehicle 1. The front sensor 111 is configured by an acceleration sensor to output the forward acceleration of the front sensor (FIS_X acceleration) to the controller 135. According to the exemplary embodiment, the front sensor 111 applies a low pass filter to the measured FIS_X acceleration to output the corresponding FIS_X acceleration.

The central sensor 131 is disposed at the center of the vehicle 1. The center of the vehicle 1 means a substantial center, a substantial structural center, or a weight center in respect to the forward direction and the lateral direction of the vehicle 1. The central sensor 131 is disposed at the center of a room of the vehicle 1. The central sensor 131 may be integrated with the controller 135.

The central sensor 131 measures the forward acceleration of the vehicle 1. The central sensor 131 is configured by the acceleration sensor to output the forward acceleration of the central sensor (ACU_X acceleration) to the controller 135. According to the exemplary embodiment, the central sensor 131 applies the low pass filter to the measured ACU_X acceleration to output the corresponding ACU_X acceleration.

The central sensor 131 measures the lateral acceleration of the vehicle 1. The central sensor 131 is configured by the acceleration sensor to output the lateral acceleration of the central sensor (ACU_Y acceleration) to the controller 135. According to the exemplary embodiment, the central sensor 131 applies the low pass filter to the measured ACU_Y acceleration to output the corresponding ACU_Y acceleration.

The left side sensor 121 is disposed at the left side of the vehicle 1. The left side sensor 121 is disposed on a left frame or a left door of the vehicle 1. The left side sensor 121 is preferably disposed on the same line as the central sensor 131 in the lateral direction of the vehicle 1.

The left side sensor 121 measures the forward acceleration of the vehicle 1. The left side sensor 121 is configured by the acceleration sensor to output the forward acceleration of the left side sensor (SYS_LH_X acceleration) to the controller 135. According to the exemplary embodiment, the left side sensor 121 applies the low pass filter to the measured SYS_LH_X acceleration to output the corresponding SYS_LH_X acceleration.

The left side sensor 121 measures the lateral acceleration of the vehicle 1. The left side sensor 121 is configured by the acceleration sensor to output the lateral acceleration of the left side sensor (SYS_Y acceleration) to the controller 135. According to the exemplary embodiment, the left side sensor 121 applies the low pass filter to the measured SYS_Y acceleration to output the corresponding SYS_Y acceleration.

The right side sensor 123 is disposed at the right side of the vehicle 1. The right side sensor 123 is disposed on a right frame or a right door of the vehicle 1. The right side sensor 123 is preferably disposed on the same line as the central sensor 131 in the lateral direction of the vehicle 1. Further, the right side sensor 123 is preferably disposed on the same line as the left side sensor 121 in the lateral direction of the vehicle 1.

The right side sensor 123 measures the forward acceleration of the vehicle 1. The right side sensor 123 is configured by the acceleration sensor to output the forward acceleration of the right side sensor (SYS_RH_X acceleration) to the controller 135. According to the exemplary embodiment, the right side sensor 123 applies the low pass filter to the measured SYS_RH_X acceleration to output the corresponding SYS_RH_X acceleration.

The right side sensor 123 measures the lateral acceleration of the vehicle 1. The right side sensor 123 is configured by the acceleration sensor to output the lateral acceleration of the right side sensor (SYS_Y acceleration) to the controller 135. According to the exemplary embodiment, the right side sensor 123 applies the low pass filter to the measured SYS_Y acceleration to output the corresponding SYS_Y acceleration.

The SYS_Y acceleration may be calculated by selecting one of a plurality of lateral accelerations measured by the left side sensor 121 or the right side sensor 123 or from all of the plurality of lateral accelerations.

The controller 135 determines the small overlap collision to expand the front airbag module 151 and the side airbag module 161. The controller 135 is preferably disposed at the center of the vehicle 1 together with the central sensor 131.

The controller 135 calculates a forward speed of the front sensor (FIS_X speed) from the FIS_X acceleration, a forward speed of the central sensor (ACU_X speed) from the ACU_X acceleration, a lateral speed of the central sensor (ACU_Y speed) from the ACU_Y acceleration, a forward speed of the left side sensor (SYS_LH_X speed) from the SYS_LH_X acceleration, a forward speed of the right side sensor (SYS_RH_X speed) from the SYS_RH_X, and a lateral speed of the side sensor (SYS_Y_speed) from the SYS_Y acceleration.

The controller 135 determines the small overlap collision from a ratio of the ACU_X speed and the ACU_Y speed and a ratio of the SYS_LH_X speed and the SYS_RH_X speed.

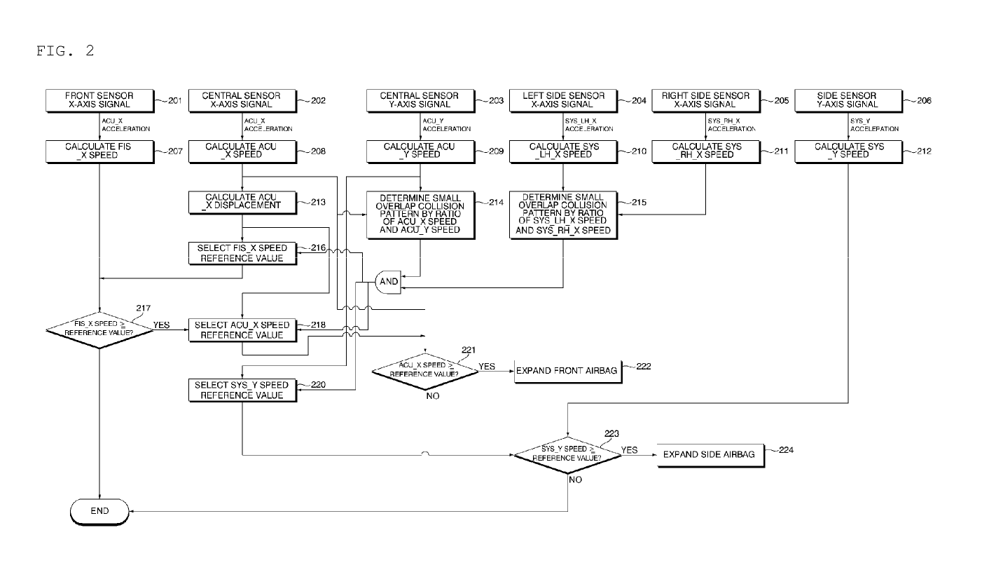

A detailed description of the controller 135 will be described below with reference to FIG. 2.

FIG. 2 is a diagram illustrating an operation of the airbag system illustrated in FIG. 1.

The controller 135 receives the FIS_X acceleration from the front sensor 111 (201), receives the ACU_X acceleration from the central sensor 131 (202), receives the ACU_Y acceleration from the central sensor 131 (203), receives the SYS_LH_X acceleration from the left side sensor 121 (204), receives the SYS_RH_X acceleration from the right side sensor 123 (205), and receives the SYS_Y acceleration from the left side sensor 121 and/or the right side sensor 123 (206).

The controller 135 integrates the FIS_X acceleration to calculate the FIS_X acceleration (207), integrates the ACU_X acceleration to calculate the ACU_X speed (208), integrates the ACU_Y acceleration to calculate the ACU_Y speed (209), integrates the SYS_LH_X acceleration to calculate the SYS_LH_X speed (210), integrates the SYS_RH_X acceleration to calculate the SYS_RH_X speed (211), and integrates the SYS_Y acceleration to calculate the SYS_Y speed (212). Further, the controller 135 integrates the ACU_X speed to calculate a forward displacement of the central sensor (ACU_X displacement) (213).

The controller 135 determines whether the small overlap collision occurs and a type of the small overlap collision with the ratio of the ACU_X speed and the ACU_Y speed (214). The controller 135 determines the small overlap collision as a left small overlap collision when the ratio of the ACU_X speed and the ACU_Y speed is equal to or more than a central sensor left reference value and as a right small overlap collision when the ratio of the ACU_X speed and the ACU_Y speed is equal to or more than a central sensor right reference value. The central sensor left reference value and the central sensor right reference value are previously set to be stored in the controller 135.

According to the exemplary embodiment, the controller 135 may determine that the small overlap collision occurs without distinguishing the left and right sides when the ratio of the ACU_X speed and the ACU_Y speed is equal to or more than a central sensor reference value.

The controller 135 determines whether the small overlap collision occurs and the type of the small overlap collision with the ratio of the SYS_LH_X speed and the SYS_RH_X speed (215). The controller 135 determines the small overlap collision as the left small overlap collision when the ratio of the SYS_LH_X speed and the SYS_RH_X speed is equal to or more than a side sensor left reference value and as the right small overlap collision when the ratio of the SYS_LH_X speed and the SYS_RH_X speed is equal to or more than a front sensor right reference value. The side sensor left reference value and the side sensor right reference value are previously set to be stored in the controller 135.

According to the exemplary embodiment, the controller 135 may determine that the small overlap collision occurs without distinguishing the left and right sides when the ratio of the SYS_LH_X speed and the SYS_RH_X speed is equal to or more than the side sensor reference value.

When the controller 135 determines both the ratio of the ACU_X speed and the ACU_Y speed as the left small overlap collision or the ratio of the SYS_LH_X speed and the SYS_RH_X speed as the left small overlap collision or both the ratio of the ACU_X speed and the ACU_Y speed as the left small overlap collision or the ratio of the SYS_LH_X speed and the SYS_RH_X speed as the right small overlap collision, the controller 35 determines that the small overlap collision occurs (219). According to the exemplary embodiment, when the controller 135 determines both the ratio of the ACU_X speed and the ACU_Y speed as the left small overlap collision or the ratio of the SYS_LH_X speed and the SYS_RH_X speed as the small overlap collision without distinguishing the left and right sides, the controller 135 may determine that the small overlap collision occurs.

When the controller 135 determines that the small overlap collision occurs, the controller 135 selects the front sensor forward reference value (FIS_X reference value) for the FIS_X speed from the ACU_X displacement (216). The FIS_X reference value is stored in the controller 135 in a lookup table form, and as a result, the controller 135 selects the FIS_X reference value from a lookup table according to the ACU_X displacement.

The controller 135 determines whether the FIS_X speed is equal to or more than the FIS_X reference value (217). The controller 135 determines that the small overlap collision occurs and when the FIS_X speed is equal to or more than an FIS_X reference value, the controller 135 selects a forward reference value of the central sensor (ACU_X reference value) from the ACU_X displacement (218). The ACU_X reference value is stored in the controller 135 in the lookup table form, and as a result, the controller 135 selects the ACU_X reference value from the lookup table according to the ACU_X displacement.

The controller 135 determines whether the ACU_X speed is equal to or more than the ACU_X reference value (221). The controller 135 expands the front airbag module 151 when the ACU_X speed is equal to or more than the ACU_X reference value (222). When the controller 135 transmits an expansion signal to the front airbag module 151, the front airbag mounted on the front airbag module 151 is expanded.

When the controller 135 determines that the small overlap collision occurs, the controller 135 selects the side sensor lateral reference value (SIS_Y reference value) for the SIS_Y speed from the ACU_Y speed (220). The SIS_Y reference value is stored in the controller 135 in the lookup table form, and as a result, the controller 135 selects the SIS_Y reference value from the lookup table according to the ACU_X speed.

The controller 135 determines whether the SIS_Y speed is equal to or more than the SIS_Y reference value (223). The controller 135 expands the side airbag module 161 when the SIS_Y speed is equal to or more than the SIS_Y reference value (224). When the controller 135 transmits the expansion signal to the side airbag module 161, the side airbag mounted on the side airbag module 161 is expanded.

While the exemplary embodiments of the present invention have been illustrated and described above, the present invention is not limited to the aforementioned specific exemplary embodiments, various modifications may be made by a person with ordinary skill in the technical field to which the present invention pertains without departing from the subject matters of the present invention that are claimed in the claims, and these modifications should not be appreciated individually from the technical spirit or prospect of the present invention.

What is claimed is:

1. An airbag system comprising:
a front airbag module expanded to a front of the passenger to protect the front of the passenger;
a side airbag module expanded to the side of the passenger to protect the side of the passenger;
a central sensor disposed at the center of a vehicle, and measuring the forward acceleration to output a forward acceleration of the central sensor and measuring a lateral acceleration to output a lateral acceleration of the central sensor;
a left side sensor disposed on a left side of the vehicle, and measuring the forward acceleration to output a forward acceleration of the left side sensor and measuring the lateral acceleration to output a lateral acceleration of the left side sensor;
a right side sensor disposed on a right side of the vehicle, and measuring the forward acceleration to output a forward acceleration of the right side sensor and measuring the lateral acceleration to output a lateral acceleration of the right side sensor; and
a controller configured to determine a small overlap collision from the forward acceleration of the central sensor and the lateral acceleration of the central sensor, and the forward acceleration of the left side sensor and the forward acceleration of the right side sensor to expand the front airbag module and the side airbag module.

2. The airbag system of claim 1, wherein the controller is configured to calculate a forward speed of the central sensor from the forward acceleration of the central sensor, a lateral speed of the central sensor from the lateral acceleration of the central sensor, a forward speed of the left side sensor from forward acceleration of the left side sensor, and a forward speed of the right side sensor from the forward acceleration of the right side sensor to determine whether the small overlap collision occurs from a ratio of the forward speed of the central sensor and the lateral speed of the central sensor and a ratio of the forward speed of the left side sensor and the forward speed of the right side sensor.

3. The airbag system of claim 2, further comprising:
a front sensor disposed on a front of the vehicle, and measuring a forward acceleration to output a forward acceleration of the front sensor,
wherein the controller is configured to:
calculate a forward speed of the front sensor from the forward acceleration of the front sensor,
calculate a forward displacement of the central sensor from the forward speed of the central sensor,
select a reference value for the forward speed of the front sensor from the forward displacement of the central sensor when determining that the small overlap collision occurs, and
determine whether the forward speed of the front sensor is equal to or more than the reference value.

4. The airbag system of claim 2, wherein the controller is configured to:
calculate the forward displacement of the central sensor from the forward speed of the central sensor,
select a reference value for the forward speed of the central sensor from the forward displacement of the central sensor when determining that the small overlap collision occurs, and
expand the front airbag module when the forward speed of the central sensor is equal to or more than the reference value.

5. The airbag system of claim 2, wherein the controller is configured to:
calculate a side lateral speed from the lateral acceleration of the left side sensor or the lateral acceleration of the right side sensor,
select a reference value for the lateral speed of the side sensor from the lateral speed of the central sensor when determining that the small overlap collision occurs, and
expand the side airbag module when the lateral speed of the side sensor is equal to or more than the reference value.
